(19) United States
(12) Patent Application Publication
(10) Pub. No.: US 2006/0160486 A1
(43) Pub. Date: Jul. 20, 2006

(54) Method and system for converting streaming digital data to FM modulated data

(75) Inventors: Joseph Smallcomb, Lake Worth, FL (US); Daniel Morera, Boynton Beach, FL (US)

Correspondence Address: AKERMAN SENTERFITT, P.O. BOX 3188, WEST PALM BEACH, FL, 33402-3188, US

(73) Assignee: XM Satellite Radio, Inc., Washington, DC (US)

(21) Appl. No.: 11/035,456

(22) Filed: Jan. 14, 2005

(51) Int. Cl. H04H 1/00

(52) U.S. Cl. 455/3.02

(57) ABSTRACT

A system (10) for converting streaming digital data to frequency modulated data includes a digital decoder (12) providing content and associated data, a system controller (14) for formatting the associated data into frequency modulated sub-carrier data, and a frequency modulator (20) for modulating (24) the content and combining (25) the modulated content with a buffered version of the frequency modulated sub-carrier data. The streaming digital data can come from a satellite digital audio radio system receiver and the associated data can include at least one among a channel name, a channel number, an artist name, a song title, and traffic information. The system controller can format the associated data into an RDS Message format. The frequency modulator can include an RDS physical layer (32) and an RDS data link layer (30) that can generate a checksum. The frequency modulator can also include a register or buffer (28).

### CROSS-REFERENCE TO RELATED APPLICATIONS

(NOT APPLICABLE)

### FIELD OF THE INVENTION

The invention relates generally to a method and apparatus for wirelessly providing a source signal and associated data to a radio frequency receiver, and more particularly to a method and apparatus for wirelessly providing a source signal and the associated data via a sub-carrier signal to a radio frequency receiver.

### BACKGROUND OF THE INVENTION

Satellite radio operators are providing digital radio broadcast services covering the entire continental United States. These services offer approximately 100 channels, of which nearly 50 channels in a typical configuration provides music with the remaining stations offering news, sports, talk and data channels. Briefly, the service provided by XM Satellite Radio includes a satellite X-band uplink to two satellites which provide frequency translation to the S-band for re-transmission to radio receivers on earth within a coverage area. Radio frequency carriers from one of the satellites are also received by terrestrial repeaters. The content received at the repeaters is retransmitted at a different S-band carrier to the same radios that are within their respective coverage areas. These terrestrial repeaters facilitate reliable reception in geographic areas where LOS reception from the satellites is obscured by tall buildings, hills, tunnels and other obstructions. The signals transmitted by the satellites and the repeaters are received by SDARS receivers which can be located in automobiles, in handheld or in stationary units for home or office use. The SDARS receivers are designed to receive one or both of the satellite signals and the signals from the terrestrial repeaters and combine or select one of the signals as the receiver output.

Existing FM radio receivers or other customized FM radio receivers can be retrofitted to receive the satellite digital radio broadcast and enable one to listen to the programming via an unused FM frequency using an RF modulator. As shown in FIG. 1, an audio system 3 can include an FM modulator 5 that is connected to a head unit 6 and corresponding FM antenna 7 via a coaxial cable or transmission line 9 to enable a full frequency response. To receive the satellite digital audio radio transmission, the audio system 3 further requires a satellite antenna 4 and an antenna module 2 coupled to a satellite receiver 1 via another coaxial cable or transmission line 8. The required cabling in an automotive environment for such a set up as shown in FIG. 1 can be a little cumbersome and involve additional cost in terms additional wiring. Furthermore, transmission of associated data transmitted in the satellite signal that is relayed via the FM modulator to any FM receiver is typically lost unless additional customized cabling, encoding and decoding is provided between the Satellite receiver and an FM receiver. The FM transmitter

FM radio stations and FM receiver equipment providers have lately introduced a Radio Data System (RDS) that provides a method of sending extra information along with VHF/FM radio services to suitable receiving equipment without affecting the normal FM radio programming. Since most FM radio stations do not use all their bandwidth, RDS takes advantage of the spare bandwidth by transmitting low bit rate digital data in the spare bandwidth using an FM sub-carrier. The RDS signal is modulated into the radio station signal and transmitted along with the radio station signal. No existing satellite radio system takes advantage of this RDS capability in current FM receivers to provide associated data via a sub-carrier using an FM modulation scheme.

### SUMMARY OF THE INVENTION

Transmission of a source signal having content data and associated data via an FM modulator can combine the content data and associated data using a sub-carrier signal. In a first embodiment in accordance with the present invention, a system for converting streaming digital data to frequency modulated data includes a digital decoder providing content and associated data, a system controller for formatting the associated data into frequency modulated sub-carrier data, and a frequency modulator for modulating the content and combining the modulated content with a buffered version of the frequency modulated sub-carrier data. The streaming digital data can come from a satellite digital audio radio system receiver and the associated data can include at least one among a channel name, a channel number, an artist name, a song title, and traffic information. The system controller can format the associated data into an RDS Message format. The frequency modulator can include an RDS physical layer and an RDS data link layer that can generate a checksum. The system controller can control the operation of the RDS physical layer. The frequency modulator can also include a register or buffer.

In a second embodiment, a method of converting digital data to FM modulated data can include the steps of decoding a digital data source into content data and associated data, formatting the associated data for FM sub-carrier transmission, frequency modulating the content data, and combining the frequency modulated content data with the frequency modulated sub-carrier formatted data. Formatting the associated data can be done by formatting the associated data into an RDS messaging format. The method can further include the step of buffering the associated data in the RDS messaging format. When using RDS, the method can further include the steps of generating a checksum, applying an offset word to the checksum, enabling the RDS processing of the associated data, generating an interrupt for formatting RDS formatted associated data to an FM modulator, and performing RDS physical layer functions such as receiving an 19 kHz input and providing a RDS modulated output.

In a third embodiment, a receiver system can include a receiver such as a satellite receiver having a decoder for decoding a digital stream into content data and associated data, a processor coupled to the receiver for processing the associated data to provide processed associated data, and a frequency modulator coupled to the decoder and the processor, wherein the frequency modulator combines the content data with the processed associated data on a sub-carrier. The system can further include an antenna from transmitting the combined content data and processed associated data from the frequency modulator.

### BRIEF DESCRIPTION OF THE DRAWINGS

FIG. 1 is block diagram of an existing satellite digital audio radio receiver system.

FIG. 2 illustrates a radio system having an FM modulator that combines content and associated data in accordance with an embodiment of the present invention.

FIG. 3 is a block diagram of a radio system using an RDS physical layer in accordance with an embodiment of the present invention.

FIG. 4 is a block diagram of a satellite digital audio radio receiver system in a vehicle in accordance with an embodiment of the present invention.

FIG. 5 is a block diagram of a portion of the satellite receiver system of FIG. 4 further detailing the coupling network in accordance with and embodiment the present invention.

FIG. 6 is an illustration depicting an RDS Packet Structure in accordance with an embodiment of the present invention.

FIG. 7 is an illustration depicting a checksum and offset word generation in a data link layer of the FM modulator of FIG. 2 in accordance with an embodiment of the present invention.

FIG. 8 is an illustration depicting an offset word position in accordance with an embodiment of the present invention.

FIG. 9 is a flowchart illustrating a method in accordance with an embodiment of the present invention.

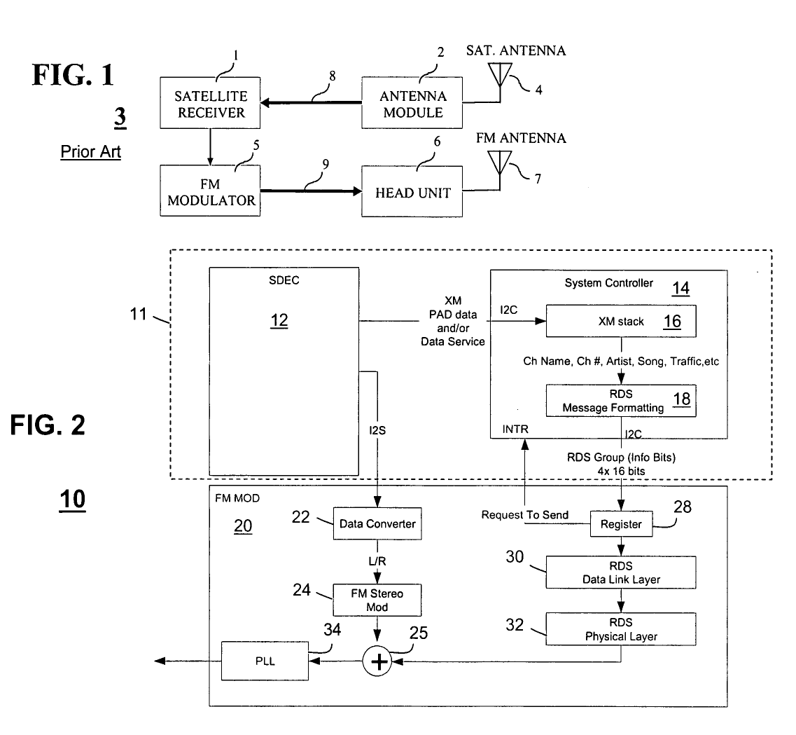

### DETAILED DESCRIPTION OF THE DRAWINGS

As previously mentioned, no existing Satellite Radio system takes advantage of the RDS or sub-carrier signaling available on VHF/FM frequencies to avoid additional physical cabling that might otherwise be required to transmit associated data from a satellite receiver to a FM modulator for eventual audio output from an FM receiver. The FM modulator proposed herein presents an for consumers for receiving satellite radio programming and associated data inside of vehicles or elsewhere.

Referring to FIG. 2, a satellite digital audio radio system 10 can include a satellite receiver 11 having a signal decoder 12 for decoding content (such as songs, talk shows, etc.) and associated data (such as channel names, channel numbers, song titles, artist names, traffic data, weather data, etc.). The content from the decoder 12 is sent to an FM modulator 20 having a data converter 22 and an FM Stereo modulator 24 for converting the content into left and right channels and modulating the content for stereo reception by an FM receiver (not shown). The associated data is sent to a processor or system controller 14. In the case of an XM Satellite receiver, the system controller 14 can further include a stack 16 for storing such associated data and a formatter 18 for converting XM satellite associated data formatting to RDS message formatting. The FM modulator 20 can further include a register 28 for receiving the associated data in RDS format upon providing an interrupt signal to the system controller 18, an RDS Data link layer 30, and an RDS Physical Layer 32 to provide a data signal that is combined with the FM stereo modulated content signal using the adder 25. A phase lock loop 34 ultimately aides in transmitting the content on an FM channel and the associated data on an FM sub-carrier.

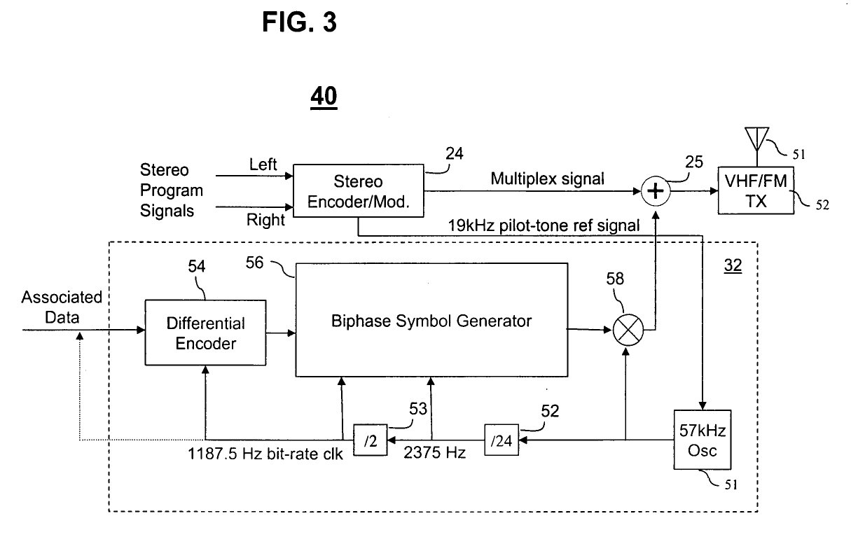

Referring to FIG. 3, a more detailed view of the RDS physical layer is illustrated along with various external components in a system 40. Stereo program signals (content) can be FM modulated by the stereo encoder/modulator 24 which provides a multiplexed signal to summer 25. The encoder/modulator further provides a 19 kHz pilot-tone reference signal to the RDS Physical Layer 32. The RDS signal is modulated to a 57 kHz subcarrier using the oscillator 51. To minimalize the audible interference to an FM radio station or channel, the data rate must be kept low, so a data rate of 1187.5 bits/second is used. This number was chosen because it can easily be derived from the carrier signal by dividing it by 48 using divide by twenty-four divider 52 and divide by two divider 53. In an RDS scheme, the associated data signal is processed through a differential encoder 54, a biphase symbol generator 56 and mixed at a mixer 58 with a 57 kHz signal before being combined with the multiplex signal (content) at summer 25. The combined signal can be transmitted via tranmitter 52 and antenna 51.

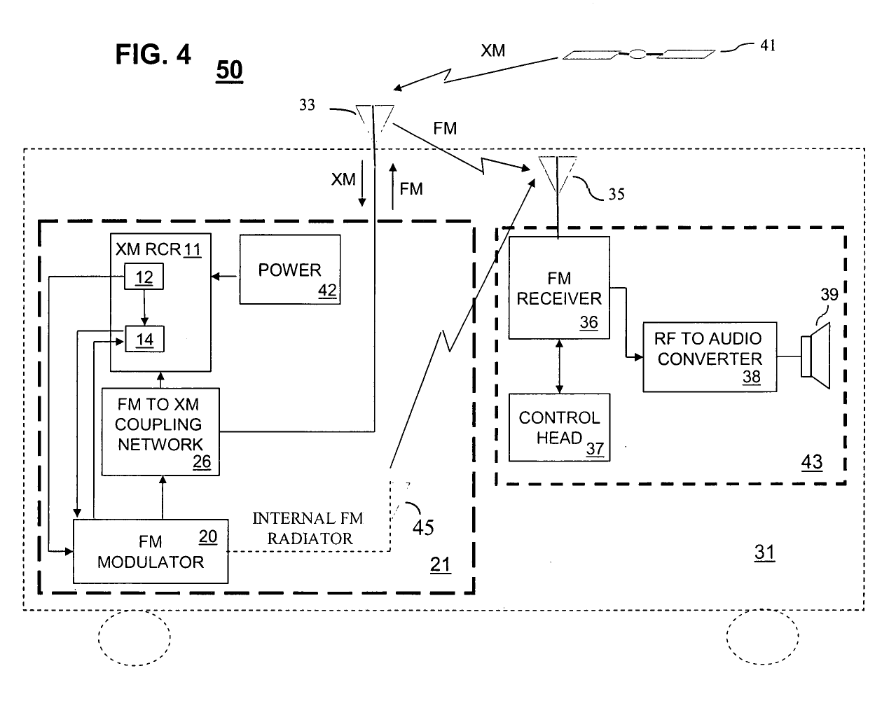

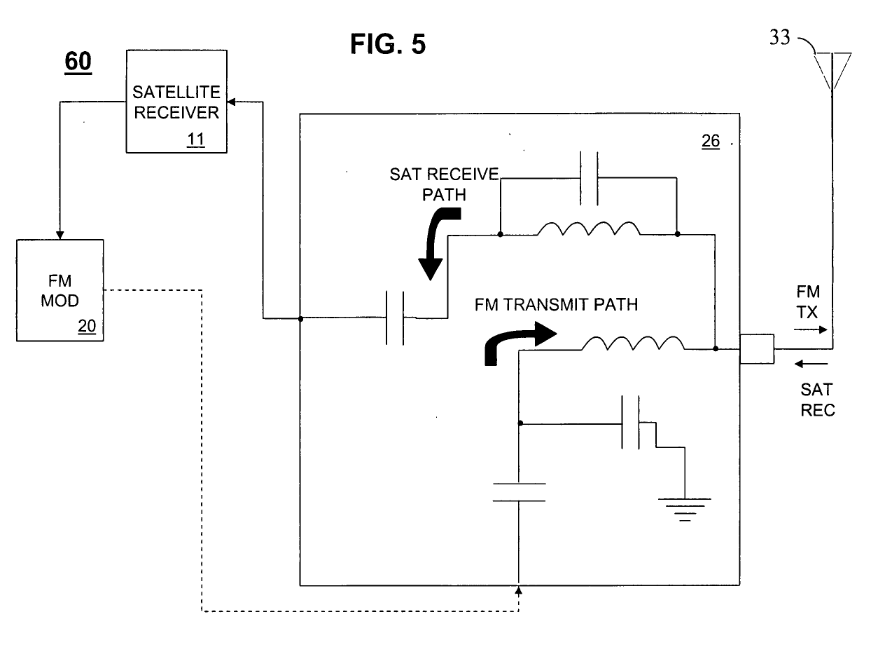

Referring to FIG. 4, another SDARS system 50 is shown as used with a vehicle 31 including a satellite receiver unit 21 having an external antenna 33 (used with the FM modulator 20) that serves as both an FM external radiating antenna and an SDARS receiving antenna for receiving satellite signals from at least one satellite 41. The FM modulator 20 can convert the SDARS signal to an FM signal. The wire from the antenna 33 can be coupled to a satellite receiver such as XM's Radio receiver unit 11 via an coupling network 26. As will be explained in further detail with respect to FIG. 5, the coupling network 26 enables the use of a single antenna to both transmit FM signals and receive satellite signals. Optionally, separate antennas can be used for just receiving the XM satellite signal (without requiring the coupling network 26) and for radiating or transmitting the FM modulated signal via an optional second antenna 45. The receiver unit 11 can also decoder 12 and system controller 14 as described with respect to FIG. 2. The receiver unit 21 can be powered by a power source 42 which can be provided by the automobile 31 or otherwise. Note, the automobile 31 can come with a factory installed or after-market installed AM/FM radio 43 including an FM receiver 36, a control head 37, RF to audio converter 38, speakers 39 and an FM receive antenna 35. In this embodiment, the receiver 36 can decode the RDS signaling (associated data) and the control head 37 can display the associated data. As previously noted, the FM receive antenna 35 is typically placed externally or embedded in glass 33 such as a front or rear windshield. In this arrangement, the satellite receiver unit 21 provides optimum FM reception for any automobile FM antenna configuration without any additional cabling.

Referring to FIG. 5, the satellite receiver system 60 is shown including the satellite receiver 11 the radio frequency modulator 20 and the coupling network 26 in greater detail. As shown, the inductor and capacitor values for the components shown are provided such that the satellite receive path is seen as a short circuit for satellite signals in the S Band and an open circuit for FM received signal. Similarly, the inductor and capacitor values for the components on the FM transmit path create essentially a short circuit for FM transmit signals and an open circuit for satellite signals in the S Band. In such a manner, a single antenna 33 can be used for both receiving satellite signals in the S band and transmitting FM modulating signals as more fully detailed in pending U.S. application Ser. No. 10/______ incorporated herein by reference.

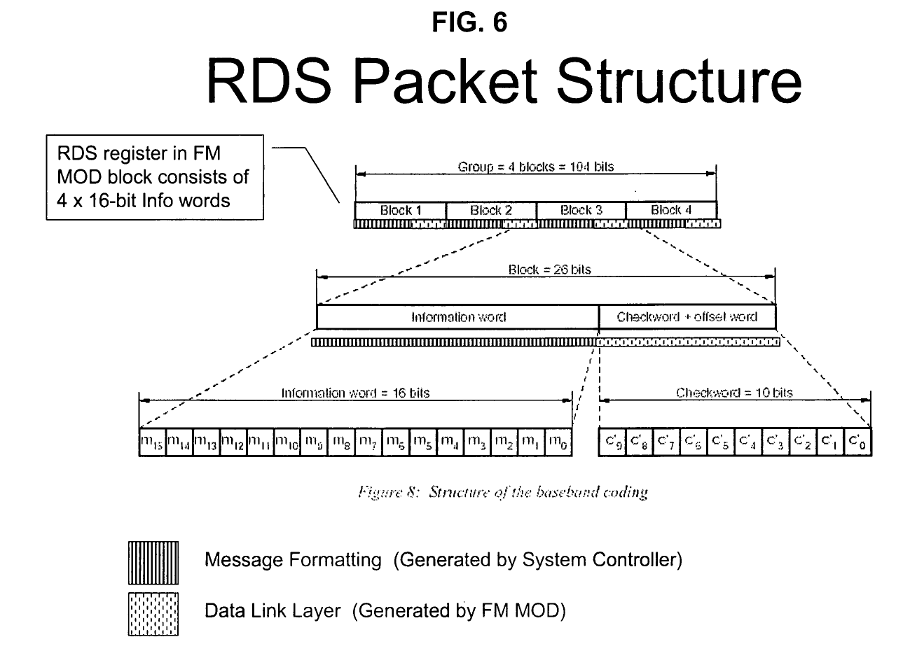

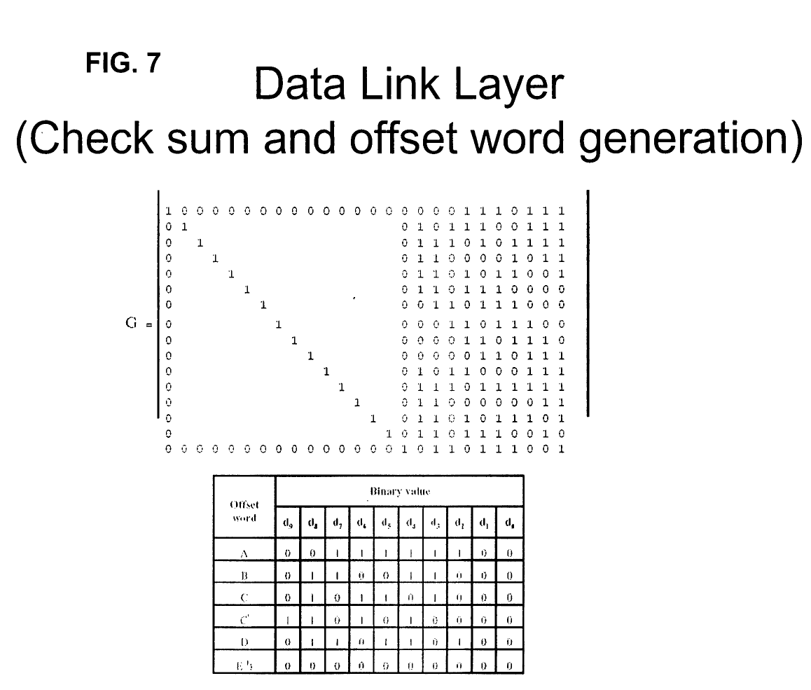

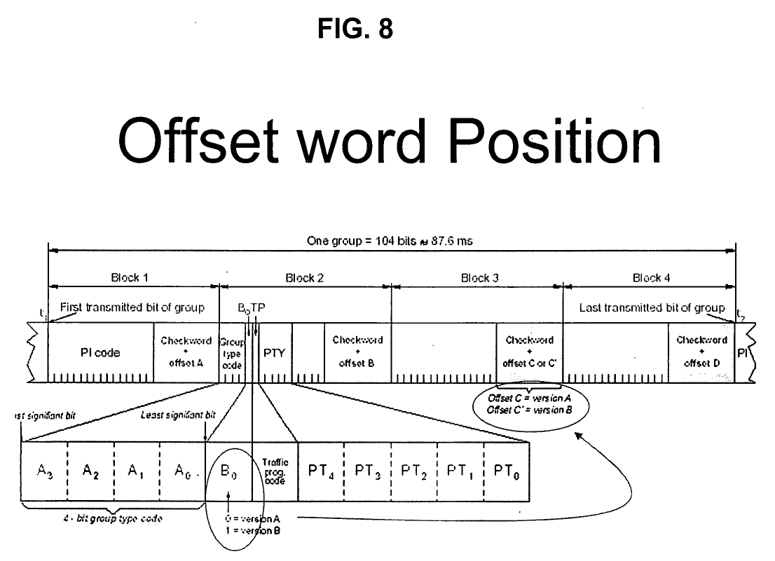

Referring to FIG. 6, an RDS packet structure is illustrated. In this embodiment, a 26 bit block contains a 16 bit information word and a 10 bit checkword. Each 104 bit Group in the RDS packet structure contains four 26 bit blocks. The information word can provide the message formatting generated by the system controller 14 of FIG. 2. The checkword can be generated by the data link layer 30. Note, the RDS register 28 in the FM modulator 20 of FIG. 2 can consist of 4×16-bit Information words. Referring to FIG. 7, a checksum and offset word generation scheme of the RDS data link layer is illustrated. Further details of the information word and checkword structure including the Offset word position is illustrated in FIG. 8. Within a block, a information word can include a 4 bit group type code (A), a version code (B), a traffic program code and additional codes (PTY). The version code can indicate which offset version should be used in a particular block.

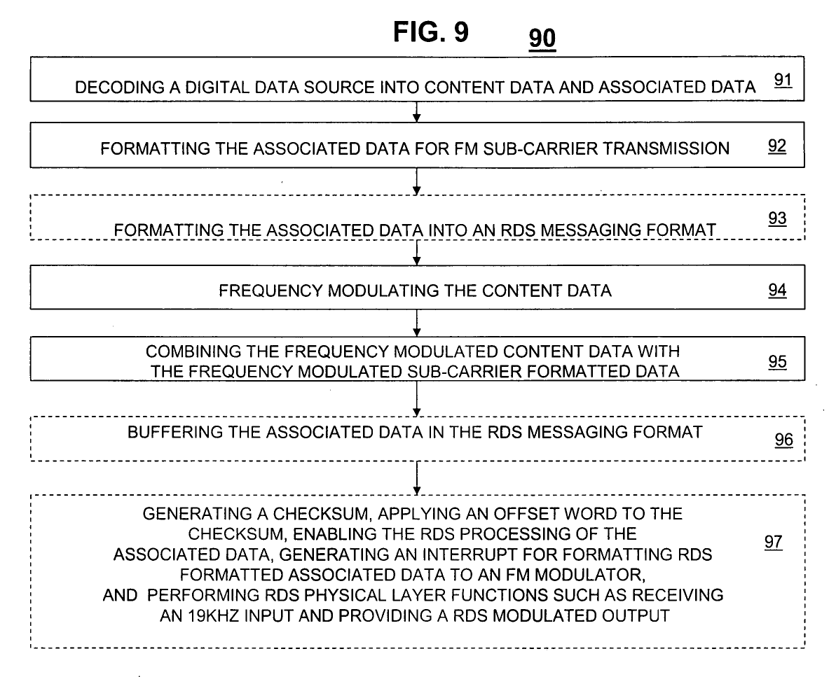

Referring to FIG. 9, a flow chart illustrating a method 90 of converting digital data to FM modulated data can include the step 91 of decoding a digital data source into content data and associated data, formatting the associated data for FM sub-carrier transmission at step 92, frequency modulating the content data at step 94, and combining the frequency modulated content data with the frequency modulated sub-carrier formatted data at step 95. Formatting the associated data can be done by formatting the associated data into an RDS messaging format as shown at optional step 93. The method 90 can further include the optional step 96 of buffering the associated data in the RDS messaging format. When using RDS, the method 90 can further include the steps of generating a checksum, applying an offset word to the checksum, enabling the RDS processing of the associated data, generating an interrupt for formatting RDS formatted associated data to an FM modulator, and performing RDS physical layer functions such as receiving an 19 kHz input and providing a RDS modulated output as shown at block 97.

The description above is intended by way of example only and is not intended to limit the present invention in any way except as set forth in the following claims.

1. A system for converting streaming digital data to frequency modulated data, comprising:
a digital decoder providing content and associated data;
a system controller for formatting the associated data into frequency modulated sub-carrier data;
a frequency modulator for modulating the content and combining the modulated content with a buffered version of the frequency modulated sub-carrier data.

2. The system of claim 1, wherein the streaming digital data comes from a satellite digital audio radio system receiver.

3. The system of claim 1, wherein the associated data includes at least one among a channel name, a channel number, an artist name, a song title, and traffic information.

4. The system of claim 1, wherein the system controller formats the associated data into an RDS Message format.

5. The system of claim 1, wherein the frequency modulator further comprises a buffer.

6. The system of claim 1, wherein the frequency modulator generates a check sum.

7. The system of claim 6, wherein the checksum is generated in a RDS data link layer.

8. The system of claim 1, wherein the frequency modulator is an FM frequency modulator further including a RDS physical layer.

9. The system of claim 8, wherein the system controller controls the operation of the RDS physical layer.

10. A method of converting digital data to FM modulated data, comprising the steps of:
decoding a digital data source into content data and associated data;
formatting the associated data for FM subcarrier transmission;
frequency modulating the content data;
combining the frequency modulated content data with the frequency modulated sub-carrier formatted data.

11. The method of claim 10, wherein the step of formatting the associated data comprises formatting the associated data into an RDS messaging format.

12. The method of claim 11, wherein the method further comprises the step of buffering the associated data in the RDS messaging format.

13. The method of claim 11, wherein the method further comprises the step of generating a checksum.

14. The method of claim 11, wherein the method further comprises the step of performing RDS physical layer functions.

15. The method of claim 14, wherein the RDS physical layer receives an 19 kHz input and provides a RDS modulated output.

16. The method of claim 10, wherein the method further comprises the step of enabling the RDS processing of the associated data.

17. The method of claim 10, wherein the method further comprises the step of generating an interrupt for formatting RDS formatted associated data to an FM modulator.

18. The method of claim 10, wherein the method further comprises the step of applying an offset word to the checksum.

19. A receiver system, comprising:
a receiver having a decoder for decoding a digital stream into content data and associated data;
a processor coupled to the receiver for processing the associated data to provide processed associated data;
a frequency modulator coupled to the decoder and the processor, wherein the frequency modulator combines the content data with the processed associated data on a sub-carrier.

20. The receiver system of claim 19, wherein the system further comprises an antenna from transmitting the combined content data and processed associated data.

21. The receiver system of claim 19, wherein the receiver comprises a satellite receiver further having a satellite antenna for receiving the digital stream.
